(19) United States
(12) Patent Application Publication
(10) Pub. No.: US 2001/0026501 A1
(43) Pub. Date: Oct. 4, 2001

(54) Clutch wheel for a timepiece

(76) Inventor: Akihiro Matoge, Chiba-shi (JP)

Correspondence Address: ADAMS & WILKS, 31st Floor, 50 Broadway, New York, NY, 10004, US

(21) Appl. No.: 09/814,518

(22) Filed: Mar. 22, 2001

(30) Foreign Application Priority Data
Mar. 31, 2000 (JP) 2000-98571

(51) Int. Cl. G04B 27/04; G04B 29/00

(52) U.S. Cl. 368/191; 368/322

(57) ABSTRACT

A clutch wheel for a timepiece is formed by a metal. This comprises a cylindrical portion in which a hand setting stem penetrates slidably and relatively non-rotatable, a flange portion integrally formed with a base end of this cylindrical portion, and a plurality of teeth integrally formed on a side surface of this flange portion and radially formed in a manner surrounding the cylindrical portion from an outer peripheral surface of the cylindrical portion.

### BACKGROUND OF THE INVENTION

1. Field of the Invention

The present invention relates to a clutch wheel for a timepiece.

2. Description of the prior Art

The conventional clutch wheel manufactured by machining a metal is formed, as shown in FIG. 4, a cylindrical portion 50 in a center and a plurality of clutch teeth 51 radially provided from an outer surface of the cylindrical portion 50. The cylindrical portion is provided, in an inner peripheral surface, with a convex portion 52 and a concave portion 53 and formed such that a not-shown hand setting stem having convex and concave portions in an outer peripheral surface penetrates axially slidable and relatively non-rotatable.

In a state the hand setting stem is drawn out by one stage, the train wheel is corrected for rotation angle (hand-rotation correction). That is, in the state the hand setting stem is drawn by one stage, a hand-setting-stem convex-and-concave portion and a convex-and-concave portion of the clutch wheel engages so that the clutch wheel rotates due to rotation of the hand setting stem. The clutch wheel is formed with a plurality of clutch teeth to mesh with setting teeth of the setting wheel to deliver rotational motion to the setting wheel. The rotating setting wheel performs hand-rotation correction through the train wheel. In hand-rotation correction, gears are meshed with in the order of the clutch wheel→the setting wheel→a minute gear→a minute indicator wheel mounting a slip mechanism, a minute pinion→hour indicator wheel, thereby performing hand-rotation correction.

The conventional clutch wheel as above has the following problems:

(1) If hand-rotation correction as above is repeatedly made, the clutch wheel manufactured by machining a metal has a concentration of load to a base end of the clutch teeth, and is broken in clutch teeth and goes out of engagement with the setting wheel, disabling hand-rotation correction.

Meanwhile, if the clutch tooth base is increased in thickness, the strength improves but the spacing between the teeth become narrow. Accordingly, the clearance with the setting wheel decreases thereby stretching the clutch tooth and the setting tooth against one another and improper meshing.

(2) Because there is in the under no receiving surface upon being forged, manufacture is only by machining resulting in expensive cost.

It is a first problem of the present invention to eliminate the above problems of the prior art and provide a clutch wheel that has a clutch teeth high in strength and less liable to be broken and is inexpensive in manufacture cost.

It is a second problem of the invention to provide a timepiece clutch that has clutch teeth having a strength equivalent to or higher than the conventional but cheap in manufacture cost.

### SUMMARY OF THE INVENTION

A first form of the present invention solved the first problem is a clutch wheel for a timepiece, characterized by being formed by a metal, and comprising: a cylindrical portion in which a hand setting stem penetrates slidably and relatively non-rotatable; a flange portion integrally formed with a base end of this cylindrical portion; a plurality of teeth integrally formed on a side surface of this flange portion and radially formed in a manner surrounding the cylindrical portion from an outer peripheral surface of the cylindrical portion.

A second form of the invention solved the second problem is a clutch wheel for a timepiece, characterized by being formed by a metal, and comprising: a cylindrical portion in which a hand setting stem penetrates slidably and relatively non-rotatable; a flange portion integrally formed with a base end of this cylindrical portion; a plurality of individual teeth integrally formed on a side surface of this flange portion and radially formed in a manner surrounding the cylindrical portion spaced from an outer peripheral surface of the cylindrical portion.

A third form of the invention solved the second problem is a clutch wheel for a timepiece, characterized in that the individual tooth is in a cylindrical shape.

(Operation)

If forming as in the first form, even if hand-rotation correction is repeatedly made, load is distributed not only in a base of the clutch teeth at the cylindrical portion outer peripheral surface but also in a base of the clutch teeth to the flange side surface, breaking being less occur. Also, because forging die may use a type separated into two in an upper level of the flange due to the provision of the flange portion, it is possible to manufacture by forging a metal and reduce manufacture cost and lead time as compared to those manufactured by machining.

Furthermore, because of provision of the flange integrally formed with the base end of the cylindrical portion, the strength of the entire clutch wheel including the clutch teeth improves.

If structure as in the second or the third, manufacture by forging is made possible as mentioned before and manufacture cost can be reduced.

Furthermore, because the flange portion is provided that is integrally formed with the base end of the cylindrical portion, the strength of the entire clutch wheel improves with the strength of the clutch teeth kept equal to or higher than the conventional.

### BRIEF DESICRIPTION OF THE DRAWINGS

A preferred form of the present invention is illustrated in the accompanying drawings in which:

FIG. 1 is a perspective view showing a structure of a first embodiment of a clutch wheel of the present invention;

FIG. 2 is a perspective view showing a structure of a second embodiment of a clutch wheel of the invention;

FIG. 3 is a perspective view showing a structure of a third embodiment of a clutch wheel of the invention; and

FIG. 4 is a perspective view showing a structural example of a conventional clutch wheel.

### DETAILED DESCRIPTION OF THE PREFERRED EMBODIMENTS

Although one embodiment of the present invention will be explained below, the invention is not limited to this.

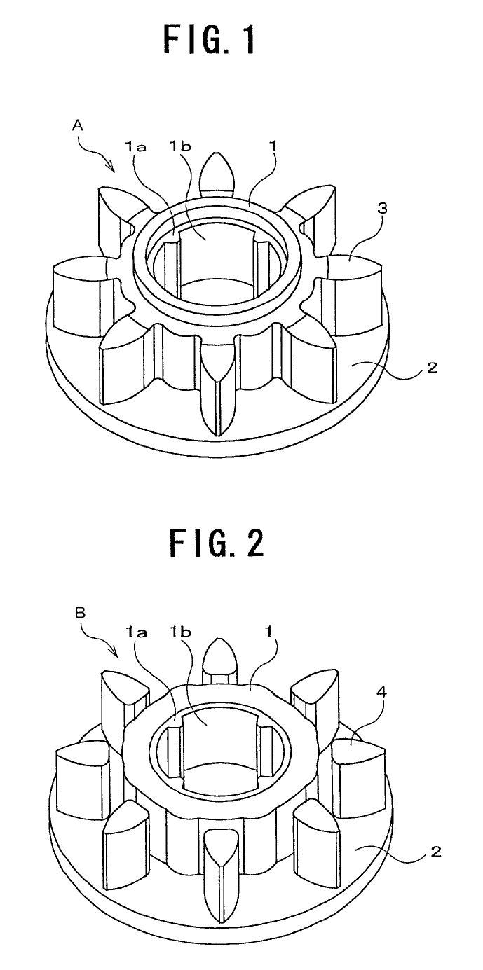

FIG. 1 is a perspective view showing a structure of one embodiment of a clutch wheel of a timepiece of the invention.

A clutch wheel A of a timepiece of the present embodiment is made of metal. The principal part is structured by a cylindrical portion 1 through which a not-shown hand setting stem penetrates slidably and relatively non-rotatably, a flange portion 2 formed integral with a base end of the cylindrical portion 1, and a plurality of teeth 3 formed integral with a lateral surface of the flange portion 2 and formed in a radial form surrounding the cylindrical portion 1 from an outer peripheral surface of the cylindrical portion 1.

In an inner periphery of the cylindrical portion 1, convex portions 1a and concave portions 1b are alternately regularly formed to be slidably and relatively non-rotatably engaged with a not-shown hand setting stem formed in cross section matched to the inner-periphery sectional shape.

Next, a second embodiment of a clutch wheel of a timepiece of the invention will be explained with reference to the attached drawings.

FIG. 2 is a perspective view of a second embodiment of a clutch wheel of a timepiece of the invention.

A clutch wheel B of a timepiece of the present embodiment is made of metal. The principal part is structured by a cylindrical portion 1 through which a not-shown hand setting stem penetrates slidably and relatively non-rotatably, a flange portion 2 formed integral with a base end of the cylindrical portion 1, and a plurality of dependent teeth 4 formed integral with a lateral surface of the flange portion 2 and formed in a radial form surrounding the cylindrical portion 1 spaced from an outer peripheral surface of the cylindrical portion 1.

Incidentally, in an inner periphery of the cylindrical portion 1, convex portions 1a and concave portions 1b are alternately regularly formed to be slidably and relatively non-rotatably engaged with a not-shown hand setting stem formed in cross section matched to the inner-periphery sectional shape, which is the same as the above first embodiment.

Next, a third embodiment of a clutch wheel of a timepiece of the invention will be explained with reference to the attached drawings.

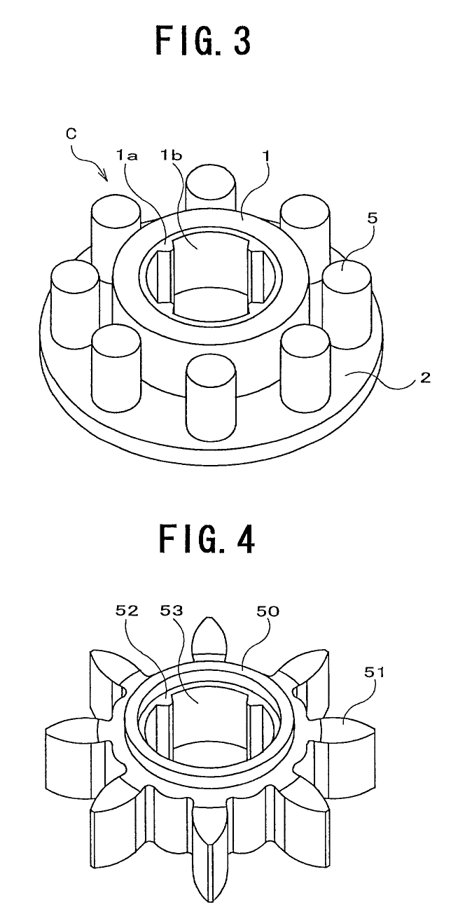

FIG. 3 is a perspective view of a third embodiment of a clutch wheel of a timepiece of the invention.

A clutch wheel C of the present embodiment is the same as the second embodiment except for the following point. That is, the individual tooth of the second embodiment was in a cross sectional form of a flower-leaf form whereas the individual tooth of the present embodiment is in a circular cross sectional shape forming a cylindrical individual tooth.

The present embodiment thus structured is simple in clutch teeth form and easy to forge as compared to the first and second embodiment, correspondingly reducing cost.

The present invention provides the following excellent effects.

(1) The clutch teeth are improved in strength and less liable to be broken as compared to the conventional machined metal clutch wheel. Because of forgeability, the clutch wheel is shortened in manufacture lead time and reduced in manufacture cost.

(2) Because the strength of the clutch tooth has a strength equivalent to or higher than the conventional machined one. Because of forgeability, the clutch wheel is shortened in manufacture lead time and reduced in manufacture cost.

What is claimed is:

1. A clutch wheel for a timepiece comprising:
a cylindrical portion in which a hand setting stem penetrates slidably and relatively non-rotatable;
a flange portion integrally formed with a base end of the cylindrical portion; and
a plurality of teeth integrally formed on a side surface of the flange portion and radially formed in a manner surrounding the cylindrical portion from an outer peripheral surface of the cylindrical portion;
wherein the clutch wheel is formed by a metal.

2. A clutch wheel for a timepiece comprising:
a cylindrical portion in which a hand setting stem penetrates slidably and relatively non-rotatable;
a flange portion integrally formed with a base end of the cylindrical portion;
a plurality of individual teeth integrally formed on a side surface of the flange portion and radially formed in a manner surrounding the cylindrical portion spaced from an outer peripheral surface of the cylindrical portion;
wherein the clutch wheel is formed by a metal.

3. A clutch wheel as claimed in claim 2, wherein the individual tooth is in a cylindrical shape.
